(19) United States
(12) Patent Application Publication
(10) Pub. No.: US 2023/0341667 A1
(43) Pub. Date: Oct. 26, 2023

(54) SYMMETRIC IMAGING PLANE FREE-FORM SURFACE OPTICAL SYSTEM HAVING A TWO-DIMENSIONAL LARGE FIELD OF VIEW

(71) Applicant: Changchun Institute Of Optics, Fine Mechanics And Physics, Chinese Academy Of Sciences, CHANGCHUN (CN)

(72) Inventors: LINGJIE WANG, CHANGCHUN (CN); XIN ZHANG, CHANGCHUN (CN); HONGBO WU, CHANGCHUN (CN); SHANGNAN ZHAO, CHANGCHUN (CN)

(21) Appl. No.: 18/342,742

(22) Filed: Jun. 28, 2023

Related U.S. Application Data
(63) Continuation of application No. PCT/CN2022/105204, filed on Jul. 12, 2022.

(30) Foreign Application Priority Data
Dec. 28, 2021 (CN) 202111622392.1

(51) Int. Cl. G02B 17/08

(52) U.S. Cl. CPC G02B 17/0848

(57) ABSTRACT

Provided by the present invention relates to the field of optical technology and is a symmetric imaging plane free-form surface optical system having a two-dimensional large field of view comprising a first reflector, a second reflector, a third reflector, a fourth reflector and a detector imaging plane which are arranged along a light path direction in sequence, and further comprising an aperture stop, wherein a position wherein the aperture stop is located at is overlapped with a position wherein the second reflector is located at such that a light beam is allowed to be reflected by the first reflector to the second reflector, after reflected by the second reflector then is injected to the third reflector, after reflected by the third reflector then is injected to the fourth reflector, after reflected by the fourth reflector then is injected to the imaging surface of the detector for imaging.

### CROSS-REFERENCE TO RELATED APPLICATIONS

This application is a continuation of co-pending International Patent Application Number PCT/CN2022/105204, filed on Jul. 12, 2022, the disclosure of which is incorporated herein by reference in its entirety.

### TECHNICAL FIELD

The present invention relates to the field of optical technology, specifically to a symmetric imaging plane free-form surface optical system having a two-dimensional large field of view.

### BACKGROUND

An off-axis reflective optical system has been used in many fields, especially in the field of cryogenic optics, because of their advantages of chromatic aberration-free, excellent heat resistance and low thermal noise. However, the off-axis reflective optical systems with traditional curved surfaces such as quadric surfaces and even-order aspheric surfaces are difficult to achieve large apertures, large fields of view, and compact envelopes at the same time due to the limited number of available design variables.

At present, the most mature and widely used off-axis system is the off-axis three-mirror reflective optical system, but the optimization of the off-axis three-mirror reflective optical system has relatively few degrees of freedom, which in turn limits the performance of the system, and is mainly reflect in in that the imaging field of view of the off-axis three-mirror reflective optical systems can generally achieve a large field of view in the X direction (sagittal direction), but is difficult to obtain a large field of view in the Y direction (meridian direction), the imaging field of view of the existing off-axis three-mirror reflective optical system can reach 17° in X direction, but the imaging field of view is about 1° in Y direction. In order to enhance another dimensional imaging field of view, the off-axis three-mirror reflective is usually improved to an off-axis four-minor reflective, such as the free-form surface off-axis four-minor reflective optical system mentioned in a patent having an application number CN2013104984537, which can reach 76° in X direction and 3° in Y direction. But still cannot meet the demand for expanded imaging field of view in Y direction for an increasing number of applications. However, they still cannot meet the expansion needs of the Y-direction imaging field of view for an increasing number of applications. And the existing off-axis four-minor reflective optical system has the common disadvantages of off-axis systems, namely, is large in size and difficult to lightweight. For the design of optical system with an aperture and a large field of view, the traditional off-axis reflective light path has the problems of large size, high distortion, weak aberration correction ability with relation to the field of view, and low imaging quality.

### SUMMARY

A purpose of the present invention is to provide a symmetric imaging plane free-form surface optical system having a two-dimensional large field of view, which is direct at the above defects of the prior art, employs four free-form surface reflectors defining symmetric planes, and is arranged in accordance with the distribution of negative-positive-positive-positive of the refractive power, wherein each of the reflectors has a tilt angle meeting the requirements of the astigmatism correction; wherein the second reflector employs a rectangular aperture design, so that when the four reflectors are arranged off-axis, the light path blocking is avoided and the arrangement space required for the four reflectors is reduced; at the same time, the imaging surface employs a curved surface image field design to reduce the image quality attenuation effect caused by the curvature of the field, which realizes the near-diffraction-limited imaging in 18°×9° two-dimensional field of view, and the system design can realize distortion correction in 3˜5 μm infrared band, and the imaging quality is close to the near-diffraction limit.

The purpose of the present invention can be achieved by the following technical measures.

The present invention provides a symmetric imaging plane free-form surface optical system having a two-dimensional large field of view, which is provided with a first reflector, a second reflector, a third reflector, a fourth reflector and an imaging plane of a detector along the direction of a light path in sequence, and the symmetric imaging plane free-form surface optical system having a two-dimensional large field of view is provided with an aperture stop, wherein a position wherein the aperture stop is located at is overlapped with a position wherein the second reflector is located at.

A reflective surface of the first reflector and a reflective surface of the second reflector are arranged to be opposite to each other, a reflective surface of the third reflector and a reflective surface of the fourth reflector are arranged to be opposite to each other, and the fourth reflector is arranged to be opposite to the imaging surface of the detector; the first reflector, the second reflector, the third reflector, the fourth reflector and the imaging surface of the detector are arranged along an off-axis direction.

The first reflector has a negative refractive power, each of the second reflector, the third reflector and the fourth reflector has a positive refractive power, each of the reflective surface of the first reflector, the reflective surface of the second reflector, the reflective surface of the third reflector and the reflective surface of the fourth reflector is a free-form surface.

The light beam is reflected by the first reflector and is injected to the second reflector, after reflected by the second reflector then is injected to the third reflector, after reflected by the third reflector then is injected to the fourth reflector, after reflected by the fourth reflector then is injected to the imaging surface of the detector for imaging.

Preferably, in the global coordinate system, with the object plane as the reference plane, the first reflector has a rotational angle of −10° to −15° with respect to the x-axis; the second reflector has a rotational angle of −52° to −60° with respect to the x-axis; the third reflector has a rotational angle of −100° to −105° with respect to the x-axis; the fourth reflector has a rotational angle of −60° to −66° with respect to the x-axis; the imaging surface of the detector has a rotational angle of −50° to −55° with respect to the x-axis.

Preferably, each of the reflective surface of the first reflector, the reflective surface of the second reflector, the reflective surface of the third reflector and the reflective surface of the fourth reflector is a free-form surface, which employs a Zernike polynomial free-form type surface, and the general expression of the Zernike polynomial free-form surface is as follow:

$$z ( ρ , φ ) = \frac{c {ρ}^{2}}{1 + \sqrt{1 - ( 1 + k )} {c}^{2} {ρ}^{2}} + {\sum }_{i = 1}^{N} {A}_{i} {Z}_{i} ( ρ , φ ) ,$$

wherein, z is a vector height of the free-form surface, c is a curvature of the free-form surface, k is a coefficient of the quadric surface, Ai is a coefficient of the Zernike polynomial expansion term, Zᵢ(ρ,φ) is the Zernike polynomial expansion term, (ρ, φ) is the polar coordinate of the free-form surface point, and N is the number of terms.

Preferably, the second reflector employs a rectangular aperture design, so that when the four reflectors are arranged off-axis, the light path blocking is avoided and the arrangement space required for the four reflectors is reduced.

Preferably, the imaging surface of the detector is a flat surface or a curved surface, and the curved imaging surface can reduce the image quality attenuation effect caused by field curvature.

The symmetric imaging plane free-form surface optical system having a two-dimensional large field of view of the present invention, the beneficial effect is that:

(1) Wide-Aperture and Large Field of View

The symmetric imaging plane free-form surface optical system having a two-dimensional large field of view of the present invention employs four free-form curved surface reflectors defining symmetric planes, at the same time, the imaging surface employs a curved surface image field design to reduce the image quality attenuation effect caused by the curvature of the field and has an equivalent aperture of 400 mm to realize the near-diffraction-limited imaging in 18°×9° two-dimensional field of view.

(2) Compact Structure

The symmetric imaging plane free-form surface optical system having a two-dimensional large field of view of the present invention comprises only four reflectors, and the four reflectors are symmetrically arranged in pairs, compact in structure and have a small occupying space.

(3) Excellent Imaging Quality, High Transfer Function and Low Distortion

The symmetric imaging plane free-form surface optical system having a two-dimensional large field of view of the present invention utilizes the reasonable design and matching of the four reflectors such that the imaging quality in the mid-wave infrared band are close to the diffraction limit; distortion is small, the relative distortion of the full field of view is ≤3.2%.

### BRIEF DESCRIPTION OF DRAWINGS

In order to more clearly illustrate the technical solutions in the embodiments or prior art of the present invention, the following will briefly introduce the accompanying drawings that need to be used in the description of the embodiments or prior art, and it is obvious that the accompanying drawings in the following description are only some embodiments of the present invention, for those skilled in the art, other accompanying drawings can be obtained according to these accompanying drawings without any creative work.

FIG. 1 is a schematic diagram of the symmetric imaging plane free-form surface optical system having a two-dimensional large field of view of the present invention;

FIG. 2 is a MTF curve of the symmetric imaging plane free-form surface optical system having a two-dimensional large field of view of an embodiment of the present invention in a short-wave band;

FIG. 3 is a distorted grid of the symmetric imaging plane free-form surface optical system having a two-dimensional large field of view of an embodiment of the present invention;

Description of the accompanying drawings is as follows: 1—the first reflector; 2—the second reflector; 3—the aperture stop; 4—the third reflector; 5—the fourth reflector; 6—the imaging plane of the detector.

### DETAILED DESCRIPTION OF EMBODIMENTS

In order to make the purpose, technical solutions and advantages of the present invention more clearly understood, the present invention will be further described below, in connection with the accompanying drawings and specific embodiments. It should be understood that the specific embodiments described herein are used only to explain the present invention and do not limit it.

In order to make the description of the present disclosure more exhaustive and complete, the following is an illustrative description of the mode of execution and specific embodiment of the present invention; however, this is not the only form of implementation or application of specific embodiments of the present invention. The mode of execution encompasses the features of several specific embodiments and the methodological steps and sequence used to construct and operate these specific embodiments. However, it is also possible to achieve the same or equivalent functionality and sequence of steps using other specific embodiments.

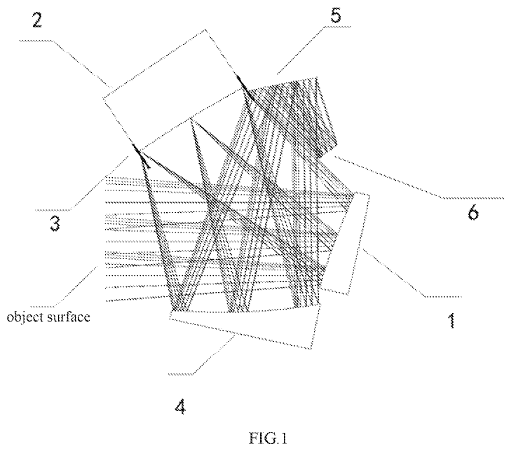

Referring to FIG. 1, the present invention provides a symmetric imaging plane free-form surface optical system having a two-dimensional large field of view, which is provided with a first reflector 1, a second reflector 2, a third reflector 4, a fourth reflector 5 and an imaging plane 6 of a detector along the direction of a light path in sequence, and the symmetric imaging plane free-form surface optical system having a two-dimensional large field of view is further provided with an aperture stop 3, wherein a position wherein the aperture stop 3 is located at is overlapped with a position wherein the second reflector 2 is located at; a reflective surface of the first reflector 1 and a reflective surface of the second reflector 2 are arranged to be opposite to each other, a reflective surface of the third reflector 4 and a reflective surface of the fourth reflector 5 are arranged to be opposite to each other, and the fourth reflector 5 is arranged to be opposite to the imaging surface 6 of the detector; the first reflector 1, the second reflector 2, the third reflector 4, the fourth reflector 5 and the imaging surface 6 of the detector are arranged along an off-axis direction; the first reflector 1 has a negative refractive power, each of the second reflector 2, the third reflector 4 and the fourth reflector 5 has a positive refractive power, each of the reflective surface of the first reflector 1, the reflective surface of the second reflector 2, the reflective surface of the third reflector 4 and the reflective surface of the fourth reflector 5 is a free-form surface; a light beam is reflected by the first reflector 1 and is injected to the second reflector 2, after reflected by the second reflector 2 then is injected to the third reflector 4, after reflected by the third reflector 4 then is injected to the fourth reflector 5, after reflected by the fourth reflector 5 then is injected to the imaging surface 6 of the detector for imaging.

The working principle of the symmetric imaging plane free-form surface optical system having a two-dimensional large field of view of the present invention is: in order to make a target object within a super-wide field of view clearly imaged on the imaging plane 6 of the detector, an off-axis four-mirror reflective optical system is used, each of the optical axis of the four reflectors is not coincident with and the optical axis of the off-axis four-mirror reflective optical system, the off-axis four-minor reflective optical system is arranged according to a xyz right-handed spatial coordinate, wherein the direction of z-axis is the direction of the optical axis, yz plane is the meridian plane of the off-axis four-mirror reflective optical system, the optical axis of the off-axis four-minor reflective optical system deflects one time, once the light beam being reflected by a reflector.

In some embodiments, in a global coordinate system, with the object plane as the reference plane, the first reflector 1 has a rotational angle of −10° to −15° with respect to the x-axis; the second reflector 2 has a rotational angle of −52° to −60° with respect to the x-axis; the third reflector 4 has a rotational angle of −100° to −105° with respect to the x-axis; the fourth reflector 5 has a rotational angle of −60° to −66° with respect to the x-axis; the imaging surface 6 of the detector has a rotational angle of −50° to −55° with respect to the x-axis. Preferably, in the global coordinate system, with the object plane as the reference plane, the first reflector 1 has a rotational angle of −12.5° with respect to the x-axis; the second reflector 2 has a rotational angle of −56.1° with respect to the x-axis; the third reflector 4 has a rotational angle of −102.1° with respect to the x-axis; the fourth reflector 5 has a rotational angle of −63° with respect to the x-axis; the imaging surface 6 of the detector has a rotational angle of −53.18° with respect to the x-axis.

In some embodiments, each of the reflective surface of the first reflector 1, the reflective surface of the second reflector 2, the reflective surface of the third reflector 4 and the reflective surface of the fourth reflector 5 is a free-form surface, which employs a Zernike polynomial free-form type surface, and the general expression of the Zernike polynomial free-form surface is as follow:

$$z ( ρ , φ ) = \frac{c {ρ}^{2}}{1 + \sqrt{1 - ( 1 + k )} {c}^{2} {ρ}^{2}} + {\sum }_{i = 1}^{N} {A}_{i} {Z}_{i} ( ρ , φ ) ,$$

wherein, z is a vector height of the free-form surface, c is a curvature of the free-form surface, k is a coefficient of the quadric surface, Ai is a coefficient of the Zernike polynomial expansion term, Zᵢ(ρ,φ) is the Zernike polynomial expansion term, (ρ,φ) is the polar coordinate of the free-form surface point, and N is the number of terms.

In some embodiments, the second reflector 2 employs a rectangular aperture design, so that when the four reflectors are arranged off-axis, the light path blocking is avoided and the arrangement space required for the four reflectors is reduced. Preferably, the second reflector 2 employs a rectangular aperture design, and the rectangular aperture has a size of 684 mm×480 mm.

In some embodiments, the imaging plane 6 of the detector is a flat surface or a curved surface, and the curved imaging surface can reduce the image quality attenuation effect caused by field curvature. Preferably, the imaging plane 6 of the detector is a curved surface having a radius of curvature of 1381 mm.

### Example 1

The technical indexes of the symmetric imaging plane free-form surface optical system having a two-dimensional large field of view are as follows:
Operation band: infrared band 3 μm-5 μm;
Entrance pupil diameter: 400 mm;
Focal length: 600 mm;
Field of view: 18°×9°;

The symmetric imaging plane free-form surface optical system having a two-dimensional large field of view of the present embodiment has a structure shown in FIG. 1, in in a global coordinate system, the position data of the vertexes of the reflective surface of the first reflector 1, the reflective surface of the second reflector 2, the reflective surface of the third reflector 4 and the reflective surface of the fourth reflector 5, and the position data of the window center of the detector relative to the object surface are detailed in table 1 below:

| Surface | x | y | z | α | β | γ |
|---|---|---|---|---|---|---|
| First reflector | 0.00000 | 0 | 900.00000 | −12.5169 | 0.0000 | 0.0000 |
| Second reflector | 0.00000 | 354.54132 | 140.85153 | −56.0510 | 0.0000 | 0.0000 |
| Third reflector | 0.00000 | −534.0673 | 186.35890 | −102.1333 | 0.0000 | 0.0000 |
| Fourth reflector | 0.00000 | 259.45666 | 594.14494 | −63.1983 | 0.0000 | 0.0000 |
| Imaging surface | 0.00000 | 71.31546 | 800.83157 | −53.1809 | 0.0000 | 0.0000 |
| of the detector | | | | | | |

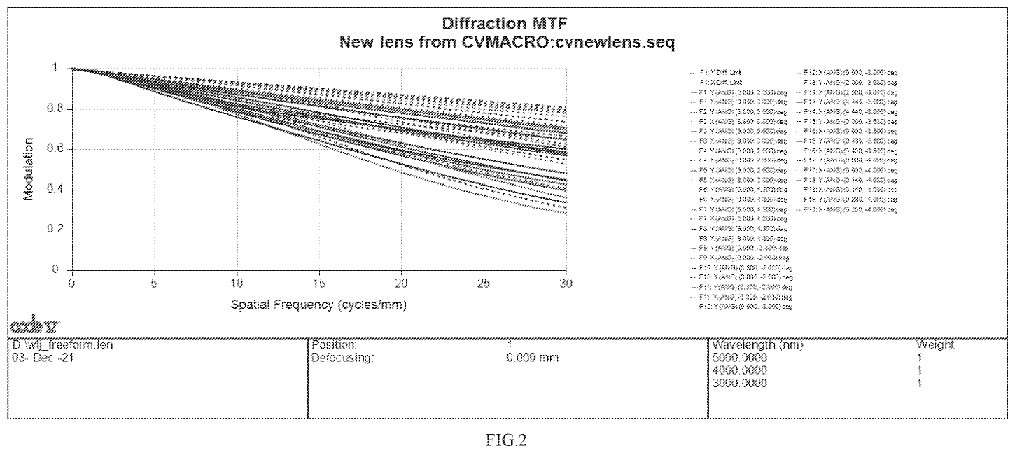

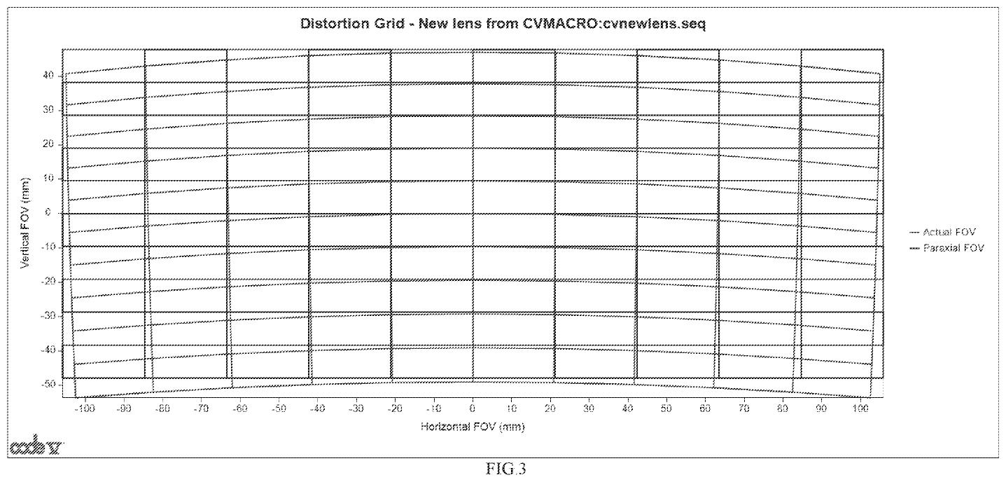

The symmetric imaging plane free-form surface optical system having a two-dimensional large field of view of the present embodiment, the imaging quality are up to the diffraction limit when its working band is a short-wave infrared band, as shown in FIG. 2; its imaging distortion is small, its distortion grid in the short-wave band is shown in FIG. 3.

The symmetric imaging plane free-form surface optical system having a two-dimensional large field of view of the present invention, the beneficial effect is that:

(1) Wide-Aperture and Large Field of View

The symmetric imaging plane free-form surface optical system having a two-dimensional large field of view of the present invention employs four free-form curved surface reflectors defining symmetric planes, at the same time, the imaging surface employs a curved surface image field design to reduce the image quality attenuation effect caused by the curvature of the field and has an equivalent aperture of 400 mm to realize the near-diffraction-limited imaging in 18°×9° two-dimensional field of view.

(2) Compact Structure

The symmetric imaging plane free-form surface optical system having a two-dimensional large field of view of the present invention comprises only four reflectors, and the four reflectors are symmetrically arranged in pairs, compact in structure and have a small occupying space.

(3) Excellent Imaging Quality, High Transfer Function and Low Distortion

The symmetric imaging plane free-form surface optical system having a two-dimensional large field of view of the present invention utilizes the reasonable design and matching of the four reflectors such that the imaging quality in the mid-wave infrared band are close to the diffraction limit; distortion is small, the relative distortion of the full field of view is ≤3.2%.

The above mentioned is only a better embodiment of the present invention, and is not used to limit the invention. Any modification, equivalent replacement and improvement made within the spirit and principles of the present invention shall be included in the scope of protection of the present invention.

What is claimed is:

1. A symmetric imaging plane free-form surface optical system having a two-dimensional large field of view, characterized in that, comprising a first reflector, a second reflector, a third reflector, a fourth reflector and a imaging plane of a detector which are arranged along the direction of a light path in sequence, and further comprising an aperture stop, wherein a position wherein the aperture stop is located at is overlapped with a position wherein the second reflector is located at; a reflective surface of the first reflector and a reflective surface of the second reflector are arranged to be opposite to each other, a reflective surface of the third reflector and a reflective surface of the fourth reflector are arranged to be opposite to each other, and the fourth reflector is arranged to be opposite to the imaging surface of the detector; the first reflector, the second reflector, the third reflector, the fourth reflector and the imaging surface of the detector are arranged along an off-axis direction; the first reflector has a negative refractive power, each of the second reflector, the third reflector and the fourth reflector has a positive refractive power, each of the reflective surface of the first reflector, the reflective surface of the second reflector, the reflective surface of the third reflector and the reflective surface of the fourth reflector is a free-form surface, such that a light beam is allowed to be reflected by the first reflector to the second reflector, after reflected by the second reflector then is injected to the third reflector, after reflected by the third reflector then is injected to the fourth reflector, after reflected by the fourth reflector then is injected to the imaging surface of the detector for imaging.

2. The symmetric imaging plane free-form surface optical system having a two-dimensional large field of view, as recited in claim 1, wherein the first reflector has a rotational angle of −10° to −15° with respect to the x-axis; the second reflector has a rotational angle of −52° to −60° with respect to the x-axis; the third reflector has a rotational angle of −100° to −105° with respect to the x-axis; the fourth reflector has a rotational angle of −60° to −66° with respect to the x-axis; the imaging surface of the detector has a rotational angle of −50° to −55° with respect to the x-axis, in a global coordinate system, with an object plane as a reference plane.

3. The symmetric imaging plane free-form surface optical system having a two-dimensional large field of view, as recited in claim 2, wherein the first reflector has a rotational angle of −12.5° with respect to the x-axis; the second reflector has a rotational angle of −56.1° with respect to the x-axis; the third reflector has a rotational angle of −102.1° with respect to the x-axis; the fourth reflector has a rotational angle of −63° with respect to the x-axis; the imaging surface of the detector has a rotational angle of −53.18° with respect to the x-axis.

4. The symmetric imaging plane free-form surface optical system having a two-dimensional large field of view, as recited in claim 1, wherein each of the reflective surface of the first reflector, the reflective surface of the second reflector, the reflective surface of the third reflector and the reflective surface of the fourth reflector is a free-form surface, which employs a Zernike polynomial free-form type surface, and the general expression of the Zernike polynomial free-form surface is as follow:
$$z ( ρ , φ ) = \frac{c {ρ}^{2}}{1 + \sqrt{1 - ( 1 + k )} {c}^{2} {ρ}^{2}} + {\sum }_{i = 1}^{N} {A}_{i} {Z}_{i} ( ρ , φ ) ,$$
wherein, z is a vector height of the free-form surface, c is a curvature of the free-form surface, k is a coefficient of the quadric surface, Ai is a coefficient of the Zernike polynomial expansion term, Zᵢ(ρ,φ) is the Zernike polynomial expansion term, (ρ,φ) is the polar coordinate of the free-form surface point, and N is the number of terms.

5. The symmetric imaging plane free-form surface optical system having a two-dimensional large field of view, as recited in claim 1, wherein the second reflector has a rectangular aperture, so that when the four reflectors are arranged off-axis, a light path blocking is avoided and an arrangement space required for the four reflectors is reduced.

6. The symmetric imaging plane free-form surface optical system having a two-dimensional large field of view, as recited in claim 5, wherein the second reflector has a rectangular aperture, and the rectangular aperture has a size of 684 mm×480 mm.

7. The symmetric imaging plane free-form surface optical system having a two-dimensional large field of view, as recited in claim 1, wherein the imaging plane of the detector is a curved surface for reducing an image quality attenuation effect caused by field curvature.

8. The symmetric imaging plane free-form surface optical system having a two-dimensional large field of view, as recited in claim 7, wherein the imaging plane of the detector is a curved surface having a radius of curvature of 1381 mm.
